(19) United States
(12) Patent Application Publication
(10) Pub. No.: US 2009/0121062 A1
(43) Pub. Date: May 14, 2009

(54) Spoon-shaped grating implement

(75) Inventors: Michael I. Silver, New York, NY (US); Wendy L. Silver, New York, NY (US); Rama Chorpash, Stalen Island, NY (US)

Correspondence Address: FITZPATRICK CELLA HARPER & SCINTO, 30 ROCKEFELLER PLAZA, NEW YORK, NY, 10112, US

(73) Assignee: Wence, L.L.C., Mount Kisco (NY)

(21) Appl. No.: 10/585,130

(22) PCT Filed: Dec. 30, 2004
(86) PCT No.: PCT/US04/43802

§ 371 Date: Oct. 1, 2008

Related U.S. Application Data
(63) Continuation-in-part of application No. 10/748,331, filed on Dec. 31, 2003, now abandoned.

(51) Int. Cl. A47J 43/25

(52) U.S. Cl. 241/168

(57) ABSTRACT

Spoon-shaped kitchen implement including a shallow bowl (110) and a handle (120). The shallow bowl (110) has a leading edge (111), a concave upper surface and a convex lower surface. The handle (120) is attached to the bowl (110) at a position substantially opposite the bowl's leading edge (111). The bowl (110) also has a plurality of grating holes (112) through it that present a rubbing zone that is sufficiently rough that a gratable foodstuff can be reduced to small particles by rubbing it on the zone. Two such implements can be pivotably joined at their handles, to form a pair of tongs (200).

### BACKGROUND AND SUMMARY OF THE INVENTION

Conventional food graters are well-known devices found and used in both professional and home kitchens. Chefs commonly use such graters to grate foodstuffs which need to be reduced to smaller particles for use in cooking or garnishing. In particular, food graters may be used for grating cheeses, carrots, ginger, garlic, citrus peel, and like foodstuffs.

A typical food grater has a rubbing section across which a gratable foodstuff is reciprocated. The rubbing section includes edges, holes and/or projections which cause the foodstuff to be reduced to smaller-sized particles when rubbed thereacross.

Typically, food grating devices are used in conjunction with other utensils when preparing meals or garnishing salads and the like. However, with the growing number of specialized cooking implements, there are now more items in the typical kitchen to use, wash and organize. Consequently, there is a need for simplicity and convenience in the area of kitchen utensils, and, as the present inventors have found, particularly with respect to food graters and serving implements.

The object of the present invention is to provide a spoon-like implement or other similar serving utensil, having a built-in grating capability. Preferably, a serving spoon, tongs, or the like, is provided with a grater capability by forming a rubbing section on the head/bowl of the implement, making a separate grating device unnecessary. Serving spoons and tongs are often used for tossing and serving salads, stirring materials being cooked in a pot (in the case of a spoon), and handling larger foodstuffs being cooked in pans and the like. Chefs often garnish salads with grated cheeses, carrots, or other such garnishments, and grate cheeses and the like over items being cooked in pots and pans on a stove to alter flavor and/or consistency of the dish. By providing a combination of a spoon-like implement and a grater, a chef does not have to search for, and later wash, multiple items. Consequently, meals can be prepared and cleaned up more efficiently. Also, when serving salads and the like at the table during a meal, a foodstuff, for example Parmesan cheese, can be grated over the salad using a serving utensil having a grating section incorporated therein, without the need for an additional utensil at the table.

While serving implements are well known in the art, combining a grating capability with such utensils has not previously been suggested.

U.S. Pat. No. 4,587,934 (Jonsson, et al.) shows an example of a typical grating tool. As shown in FIGS. 1 and 2 of that patent, the grating tool has a handle (1) and a flat blade (2). Along the flat portion of the blade, there is provided a grating section consisting of holes (31). The described device, however, is merely a stand-alone grating tool which is not configured also to work as a spoon, tongs, or the like. Thus, a user would need to use separate spoon- or tong-like utensils for serving salads, preparing meals, etc.

U.S. Pat. No. 644,732 is directed to a corn-cutting spoon. The device described in that patent is a spoon-shaped implement having a single opening (3) formed through the head (i.e., bowl) of the spoon. The opening includes teeth (4) which are adapted to cut corn kernels from a cob. No grating apertures are formed on the spoon, and thus the implement described in that patent would not provide the grating function of the present invention.

U.S. Pat. No. 4,314,724 describes hand-held tongs. The tongs include slots (18) formed in the spoon-shaped heads of the tongs. Much like a conventional slotted spoon, the slots do not have edges for grating a foodstuff, and are merely intended to allow liquid to pass therethrough. Consequently, the tongs described in that patent would also fail to provide the benefits of the present invention, and a separate grater would be needed in addition to the described tongs when any grating actions are to be performed.

### DETAILED DESCRIPTION OF THE INVENTION

The present invention addresses the problems of the prior art by providing a serving utensil having food grating abilities. More specifically, the invention is directed to a spoon-shaped implement having a bowl and a handle attached to the bowl, wherein the bowl has grating holes that form a rubbing zone that is sufficiently rough that a gratable foodstuff can be reduced to smaller particles by rubbing it on the zone.

### The Bowl

The bowl portion of the utensil of the present invention is preferably shallow, like that of a conventional spoon. The shape can mimic a conventional serving spoon, a tea spoon, and/or other such conventional spoons. Alternatively, the bowl may have a shape similar to that provided on conventionally-known serving tongs or other such utensils. Accordingly, the bowl preferably is generally curvilinear, such that it has a substantially concave upper surface and a substantially convex lower surface. The concave upper surface can correspond to the surface of the bowl of a conventional spoon that would hold liquids or other foodstuffs when being used to serve the same. The bowl can be curvilinear throughout, or it can have one or more flattened sections, as will be discussed in more detail later herein.

Preferably, the bowl includes a leading edge, which corresponds to the tip of a spoon, i.e., the side of the bowl opposite the side to which the handle is attached. In preferred embodiments, the bowl is about 2 to about 2.5 inches (about 5 to about 6.25 cm) across (widthwise direction), and about 3 to about 3.5 inches (about 7.5 to about 8.75 cm) in length (i.e., from the leading edge to the handle). The most preferred depth of the bowl is from about 0.25 to about 0.5 inch (about 0.625 to about 1.25 cm), as measured from the plane of the rim of the bowl to the bottom of the trough.

### The Handle

The handle may be of any one of a number of designs. Preferably, a handle similar to that used on a conventional spoon or the like is employed. In particular, it is preferred that the handle be an elongated member about 7 to about 9 (about 17.5 to about 22.5 cm) inches in length.

In most preferred embodiments, the handle is curved along its length, such that the curve is apparent when the bowl is viewed in profile. In particular, when the bowl of the spoon is positioned so that the concave surface of the bowl faces in a generally upward direction, the handle preferably curves up and away from the bowl, beginning at the end opposite the leading edge of the bowl. As the handle extends up and away from the bowl, the degree/severity of the curvature may reduce so that the plane of the distal end of the handle becomes closer to parallel to the plane defined by the rim of the bowl. Of course, other shapes for the handle may be provided. In particular, a straight handle may be used, particularly in embodiments where the invention forms a set of tongs.

### The Rubbing Zone

A rubbing zone is provided on the surface of the bowl for grating foodstuffs. The rubbing zone may be any structure incorporated into the bowl that causes foodstuff to be reduced into smaller particles when rubbed against the rubbing zone. The rubbing zone may be provided on the concave or convex surface of the bowl, but is preferably provided on the convex surface, such that the foodstuff is rubbed against the convex surface to perform grating.

In preferred embodiments, the rubbing zone includes a plurality of grating holes. Preferably, on the side of the bowl on which grating is to be performed, each hole includes a scooping edge. In preferred embodiments, the scooping edge arches above a curvilinear or flat plane defined by the surface of the bowl. Thus configured, when foodstuff is rubbed along the curvilinear or flat plane of the bowl the protruding scooping edge catches and scoops small particles away from the foodstuff. In this way, the spoon can be held in a horizontal position, concave side up, while a foodstuff is grated on the undersurface, and the grated particles can collect in the bowl above.

Preferably, the scooping edge is provided on substantially one side of the grating hole, and extends from that side toward the center of the hole. Thus, the scooping edge may resemble a half-dome-shaped protrusion that covers a portion of the hole. With such a configuration, as the foodstuff is rubbed across the grating hole in a direction toward the scooping edge, food particles are shaved or scooped off of the passing foodstuff by the scooping edge, and are forced through the hole, to the opposite side of the bowl, by the pressure applied by subsequently grated particles following behind. Depending upon how the spoon is oriented, when the foodstuff is held above the rubbing zone while being grated, small pieces of food pushed through the holes in the bowl may then be able to fall onto the surface/item to which the grated foodstuff is to be delivered.

The size and shape of the grating holes may be determined based on design preference and the particle size desired for grating. The hole shape, however, is preferably circular or oblong. Also, the preferred width of such a hole may be in the range of about 2 to 5 millimeters (as measured substantially across the width of the hole that the scooping edge traverses), depending on the size of the grated particles desired. Holes ranging in width from about 2 to about 3.5 mm. are especially suitable for grating ginger and garlic, while larger holes, ranging in width from about 3.5 to about 5 mm., are well suited for grating cheese and carrots. The length of the aperture and the height of the protrusion forming the scooping edge may be proportionately varied with changes in the width, in accordance with design preferences.

The direction in which the scooping edge faces may be varied in accordance with preferred designs. Preferably, however, the scooping edge faces away from the leading edge of the bowl, so that a foodstuff is grated as it is moved from the side of the bowl near the handle toward the leading edge of the bowl. In this manner, the spoon can be held in one hand, with the handle pointed up, above a pot, skillet, bowl, or plate, while the foodstuff is drawn down with the other hand, allowing the grated pieces to fall directly into the pot, skillet or dish. Also, preferably, a plurality of grating holes are provided, with each having a scooping edge. Most preferably, all of the scooping edges face in the same direction.

The number of holes to be used in one rubbing zone and the manner in which those holes are to be spaced apart on the bowl may be varied as needed. However, the rubbing zone is preferably arranged on a section of the bowl so as to have a width of about 1 to 2 inches (about 2.5 to 5 cm), and a length of about 2 to 3 inches (about 5 to 7.5 cm). Also, preferably, about 20 to about 30 holes are provided in such an area. The holes may be formed in a number of rows, with the rows preferably extending across the width of the bowl, and consecutive rows being arranged along the length of the bowl (from the leading edge toward the handle). In most preferred embodiments, each row is offset from an adjacent row such that the holes from one row are positioned substantially between the holes of the next row. In other words, the holes in adjacent rows may be shifted from each other by a distance of ½ the distance between each hole in a row, when the holes of each row are spaced apart from each other with a substantially constant period. Of course, numerous other configurations of the holes of a given rubbing zone may be used.

Each rubbing zone can be located in a curvilinear or flat section of the bowl. Locating it in a flat section generally saves on manufacturing costs.

Whether curvilinear or flat, the rubbing zone preferably is located at or near the bottom of the trough of the bowl, unless it is a zesting zone. As discussed, later herein, if a zesting zone is used preferably it is located proximate the leading edge of the bowl.

### Tongs

In another embodiment, a spoon-like implement as described above may be joined with a second spoon-like implement, with the two implements being attached so as to work together as a set of tongs. The tongs may be designed such that the implements are removably attached to each other, or permanently affixed.

The tongs may include two bowls as generally described above. Also, while only one bowl need have a rubbing zone as described above, it is preferred that each bowl have a rubbing zone. When a rubbing zone is provided on each bowl, it is also preferred that the size of the holes used in a rubbing zone of one of the bowls be different from the size of the holes for the rubbing zone of the other bowl. Thus, two grating sizes may be provided to allow for different grating abilities, for example, one fine and one coarse. Alternatively, the same size holes may be used on each bowl.

In other embodiments, one bowl with a rubbing zone may be provided, while the other tong of the set may be formed as a fork, spatula, or other tong-like implement.

The handles of the tong are preferably connected to each other at distal ends, opposite the ends attached to the bowls. Of course, other attachment points are possible. For instance, tongs may be connected to work together in a manner similar to shears or pliers, with the attachment point being provided intermediate the bowl ends and the portions of the handles gripped by the user.

The attachment of the tongs may be as simple as a flex point provided in a flexible material attaching the handles together, which allows for pivotable movement of the handles with respect to each other. These are sometimes called “living hinges.” Alternatively, the connection can be defined by a hinge that allows the handles to pivot between open and closed positions. Of course, various possible attachment scenarios may be utilized, while keeping with the intent of the present invention.

With the handles being connected in a tong-like fashion, a user may hold the handles and operate the tongs to pivot between a closed position and an open position by squeezing and releasing the handles. When a user squeezes the handles together, the handles pivot toward each other bringing the bowls (or other implements) attached thereto close to each other. When two bowls are provided, squeezing the handles to the closed position may move opposing concave surfaces of the bowls toward each other such that, when closed, the concave surfaces can grip therebetween foodstuffs, such as salad ingredients, and the like.

A biasing mechanism may be provided between the two handles to bias the handles to the open position once the user relaxes the squeezing grip on the handles. Thus, the biasing mechanism may be secured to the handles to bias the handles toward an open position, and consequently cause the bowls to move apart from each other to release foodstuffs gripped therebetween. The biasing mechanism may be a compression spring, leaf spring, or the like. Preferably, a compression spring is provided between the handles of the tongs to bias the same apart from each other.

Also, in preferred embodiments, mechanisms may be provided to stop the tongs from opening beyond a predetermined limit position, so as to define the fully open position. Preferably, the fully open position is a position in which the tong handles substantially form a “V” shape. When a hinge mechanism is used, abutment members on the opposing handles my come into contact when opening, to stop further opening by the biasing mechanism. Such mechanisms are well known in the art and will not be described in detail herein.

Also, it is preferred that the attachment point of the two handles of the tongs avoid pinch points, such that a user may open and close the tongs without a substantial risk of pinching portions of the user's skin in the moving mechanisms of the hinge or the like as the tongs open and close. This is particularly preferred when a hinge is used to connect the handles. Such a hinge may be formed by providing joints on the handles that are connected to each other by a pin that defines a common axis of rotation for the handles. Preferably, each handle has two joints. Each joint may be a substantially flat projection, with flat surfaces of each of the joints of one handle substantially opposing each other, so as to define substantially parallel planes. In such embodiments, these planes are substantially perpendicular to the axis of rotation. Holes may be provided in the flat joints so that, when corresponding joints from two handles are aligned, the openings align to allow the pin to extend through the aligned holes on the two pairs of joints to rotatably secure the handles together.

In preferred embodiments, pinch points on the thus-formed hinge are avoided by providing substantially circularly-shaped joints that overlap each other when secured together with the pin. The circular joints overlap to form a substantially constant profile when the tongs are operated, such that significant gaps do not open between the joints as the tongs are moved between the open and closed positions. Thus configured, the device may avoid having moving projections or gaps that can readily pinch or grab the skin or fingers of the hand of a user.

In addition, it is also preferred that the handles curve away from each other in positions adjacent the attachment point of the hinge (i.e., immediately next to or proximate to the attachment point). Preferably, these curved sections form rounded protrusions at the ends of the handles near the attachment point (i.e., opposite the ends attached to the bowls). These protrusions are not required and, when provided, may form shapes other than round, depending on design preferences. Rounded protrusions, however, are preferred for providing a stable gripping area that a user can hold while operating the tongs. Specifically, with the provision of such rounded protrusions, a user's hands are less likely to slide along the handles when moving the handles between the open and closed positions. Typically, the handles of tongs are substantially straight, which is not ergonomically well suited to the shape of a user's hand. The protrusions provide for a more ergonomical device. In addition, by having the handles curve away from each other at the ends, additional pinch points may be avoided between the handles themselves. In other words, the protrusions provide additional spaces between the handles that further reduce the pinch points associated with traditional tongs.

A locking mechanism may also be provided with the tongs. The locking mechanism may be used to lock the tongs in the closed position for safe and easy storage. Locking mechanisms are known in the art, and any one of a number of configurations may be used to lock the device. Some examples of such locking mechanisms will be discussed below with reference to the figures.

In other embodiments, a zesting zone may be provided on the bowl. A zesting zone is a rubbing zone specifically adapted to performing a zesting function, similar to the coarser grating function discussed above. For purposes of the terms used in the specification and claims, a zesting zone is to be considered a subset of a rubbing zone, and zesting holes a subset of grating holes. Preferably, the zesting zone is formed of a plurality of zesting holes on the bowl(s) of the tongs or spoon-like implement, and is provided in addition to or in lieu of a rubbing zone that performs a coarser grating function.

The zesting zone is preferably formed of a plurality of zesting holes in the bowl at a position proximate the leading edge of the bowl. Preferably, a plurality of zesting holes are provided along the leading edge so as to curve around the rim of the bowl near the leading edge. These holes may be formed similarly to the grating holes described above, or may be alternatively formed as simple holes without scooping edges, holes with scooping edges that do not protrude above a plane of the bowl, holes with protrusions, simple protrusions other than a scooping edge, and the like, which allow for performance of a zesting function. Specifically, the protrusions may be provided such that when a foodstuff such as a lemon peel is rubbed against the zesting zone, the zesting holes may scrape the lemon peel and break it into very small particles.

Conventional zesting devices are known in the art. Accordingly, a detailed description of the operation thereof and the differences between zesters and coarser graters will not be provided herein. In preferred embodiments, however, the zesting holes are substantially circular or oblong in shape, like the grating holes, but do not have scooping edges that protrude above the surface of the bowl. Instead of scooping edges that protrude above the plane of the bowl, it is preferred that the zesting holes have scooping edges that are substantially even with the surface of the bowl and that are defined by the edge of the bowl. Thus, in such an embodiment, the scooping edge is formed by a portion of the rim of a hole that is partly bordered by the edge of the bowl (at a side on which the zesting operation is to be performed). The scooping-edge portion of such a rim faces up and performs a scraping action that produces foodstuff particles that are generally smaller than those formed by the scooping action of standard grating holes. Of course, any one of a number of different configurations may be used to form the zesting holes of the zesting zone.

The implements of the present invention may be made of any one of a number of materials. However, it is preferred that stainless steel be used. In other embodiments, plastic, other metals, combinations thereof, etc. may be used.

Variations of the above-discussed embodiments may be used while keeping with the intended scope of the invention. In addition, features of the different embodiments may be interchanged or combined to achieve alternative designs. Provided below are preferred examples of these embodiments, for exemplary purposes.

### DETAILED DESCRIPTION OF THE PREFERRED EMBODIMENTS

### Description of the Drawings

The accompanying drawings show some preferred embodiments of the present invention.

FIG. 1 is a top plan view of a spoon according to the present invention.

FIG. 2 is a bottom plan view of a spoon as shown in FIG. 1.

FIG. 3A is a cross-sectional view of a portion of the spoon shown in FIG. 1, as taken along line A-A′.

FIG. 3B is a magnified view of part of the cross-sectional view shown in FIG. 3A.

FIG. 4 is a perspective view of a set of tongs according to the present invention.

FIG. 5 is a perspective view of the spring and locking mechanism of the tongs shown in FIG. 4, in the open position.

FIG. 6 is a perspective view of the spring and locking mechanism of the tongs shown in FIG. 4, in the closed position.

FIG. 7A is a top plan view of another spoon according to the present invention.

FIG. 7B is a cross-sectional view of a portion of the spoon shown in FIG. 7A, as taken along line 7B.

FIG. 7C is a magnified view of a part of the cross-sectional view shown in FIG. 7B.

### DISCUSSION OF DEPICTED EMBODIMENTS

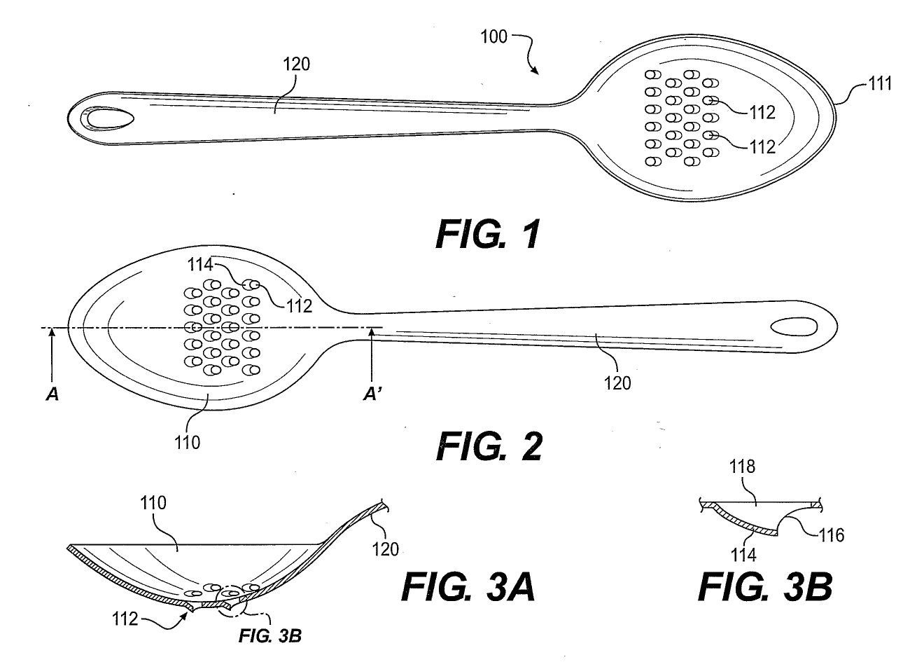

FIGS. 1-3B show one design of a spoon-like implement according to the present invention. In particular, spoon 100 includes a bowl 110 and an attached handle 120. Bowl 110 is curvilinear so as to have a concave top surface and convex bottom surface. Handle 120 is attached to the bowl at a side of the bowl opposite a leading edge 111 of bowl 110. Handle 120 extends from bowl 110 in a curved manner so as to angle slightly upward and away from bowl 110, as shown in FIG. 3A.

Provided in bowl 110 are a plurality of grating holes 112. Grating holes 112 are arranged in four widthwise rows, with the first row being arranged closest to the leading edge 111, and the last row being arranged closest to handle 120. The first row has five grating holes, the next row six holes, the following row five holes, and the last row six holes, such that the number of holes-per-row alternates. Also, the holes 112 in the first and third rows align with each other when viewed along the length of bowl 112, from the leading edge 111 to the handle 120. The holes in the second and fourth rows also align with each other, but not with the holes in the first and third rows. In this manner, the holes in adjacent rows are offset from each other by about ½ the distance between adjacent holes in a row, which, in this embodiment, is a constant distance throughout each row of the rubbing zone. Of course, as discussed above, alternative arrangement of holes are possible.

Each hole 112 has a scooping edge 114 (shown in FIG. 3B) that protrudes from the convex bottom surface of bowl 110. Scooping edge 114 partially covers channel 118 formed in bowl 110. Scooping edge 114 and the concave surface of bowl 110 define an opening 116 which is in fluid communication with channel 118 through bowl 110. The continuity of opening 116 and channel 118 form the hole 112 through bowl 110.

Thus configured, the plurality of holes 112 form a rubbing zone across which food may be grated. For instance, a foodstuff may be rubbed along the rubbing zone, starting from a portion of the convex surface of bowl 110 near handle 120, across the rubbing zone toward the leading edge of the bowl 110. As a foodstuff is moved across the rubbing zone, scooping edge 114 causes small particles of the foodstuff to be shaved off. As the rubbing motion continues, the shaved off, smaller particles are forced through opening 116 and channel 118.

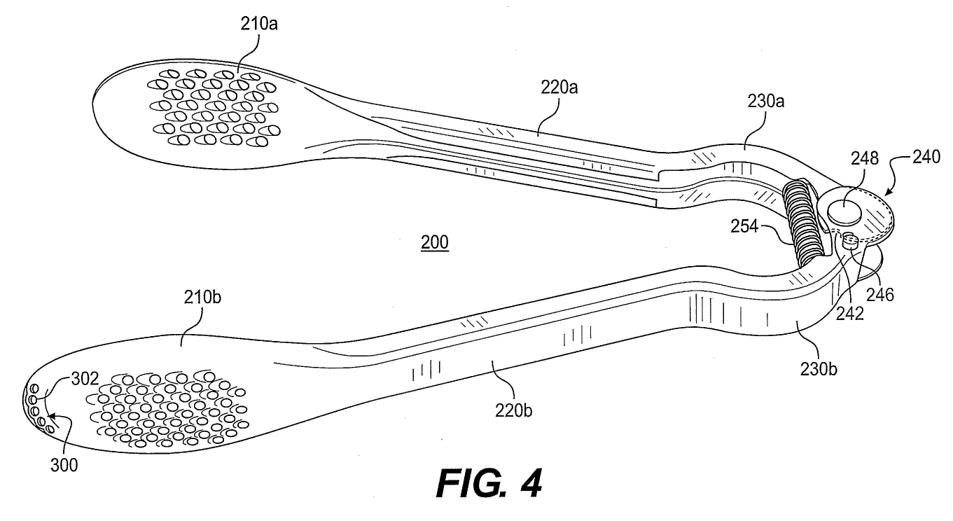

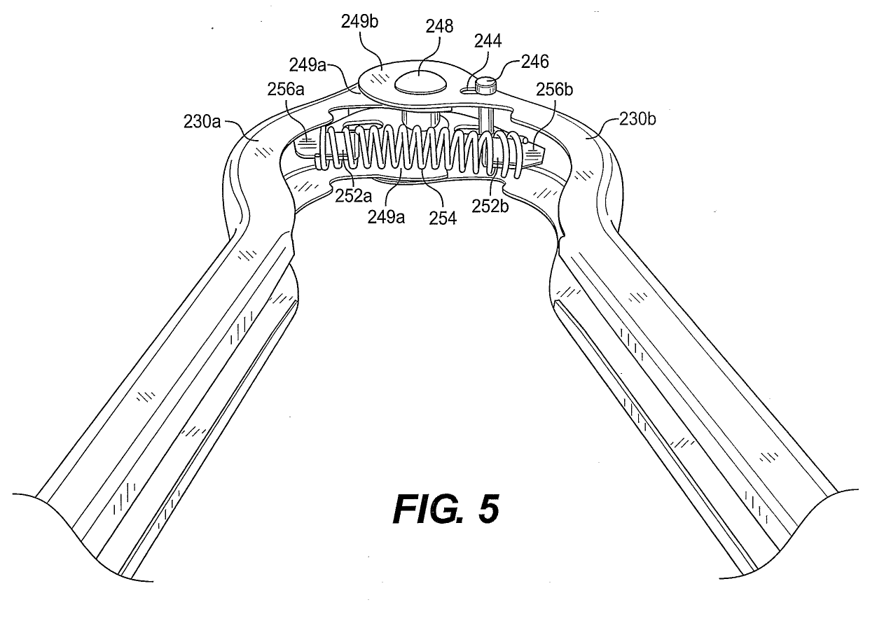

FIGS. 4-6 show another embodiment of the present invention. Specifically, FIGS. 4-6 show tongs 200. Similar to spoon 100, tongs 200 include bowls 210a and 210b and handles 220a and 220b. In this regard, tongs 200 mainly operate as a pair of spoons 100 attached together at an end of the handles opposite the bowls.

Bowls 210a and 210b are generally similar to bowl 110 discussed above, although bowls 210a and 210b are somewhat more shallow the bowl 110, in this embodiment. Accordingly, a detailed description of bowls 210a and 210b is not provided herein.

As shown in FIG. 4, unlike the previous embodiment, bowl 210b includes five zesting holes 302 formed along the perimeter of bowl 210b at the leading edge thereof. The zesting holes 302 form a zesting zone 300. Unlike the grating holes, in this embodiment no half-dome-shaped scooping edges are provided at the zesting holes 302 that extend through bowl 210b. Instead, the scooping-edge portion of the rim of each zesting hole 302 protrudes slightly above the curvilinear surface defined by the convex surface of bowl 210b, so as to provide a scraping surface against which foodstuff may be rubbed to perform a zesting action. In addition, the formation of the zesting holes 302 gives a scalloped shape to the leading edge of bowl 210b.

Handles 220a and 220b are attached to bowls 210a and 210b, respectively, at portions of those bowls opposite the leading edges thereof. In this embodiment, handles 220a and 220b are substantially straight and extend away from bowls 210a and 210b at a slight angle from the bowls, unlike handle 120 of spoon 100. The straight alignment of handles 220a and 220b provides tongs 200 with the preferred design for gripping foodstuffs between bowls 210a and 210b.

Handles 210a and 210b are connected to each other by pin 248, which provides a common rotational axis for the handles 210a and 210b. Pin 248 engages pairs of joints 249a and 249b of handles 210a and 210b when those joints are aligned. Joints 249a and joints 249b are substantially disc-shaped, with the disc-shape of each pair being substantially parallel with each other. The joints 249a and 249b receive pin 248 through holes formed therein. The joints 249a and 249b overlap to provide a substantially constant, circular profile (as viewed along the axis of rotation), so as to reduce pinch points that could pinch a user's fingers, skin, and the like. Pin 248 extends through the round joints 249a and 249b to form a hinge that secures the handles together.

At ends of handles 220a and 220b opposite the ends to which the bowls 210a and 210b are attached, but before the hinge, there are provided round protrusions 230a and 230b, respectively. Protrusions 230a and 230b are portions of handles 220a and 220b, respectively, that curve away from each other for a distance between distal portions of the handles to joints 249a and 249b. Together, protrusions 230a and 230b form a gripping region of handles 220a and 220b, which a user may grasp when operating the tongs 200. Such protrusions provide for more steady gripping, and reduce slippage of the device when being used.

Arms 256a and 256b are also positioned on pin 248 so as to rotate about an axis defined by that pin. Arms 256a and 256b are attached to handles 220a and 220b, respectively, at ends of protrusions 230a and 230b near pin 248. Thus configured, as the handles 220a and 220b open and close, so do arms 256a and 256b, and vice versa. Attached to the ends of the arms 256a and 256b opposite the ends thereof connected to pin 248 are pin members 252a and 252b, respectively. Mounted between (and on) pin members 252a and 252b is coil spring 254. Coil spring 254 provides a biasing force against pin member 252a and 252b, which is subsequently transferred to arms 256a and 256b. That biasing force is transferred from arms 256a and 256b to handles 220a and 220b. Consequently, when a user relaxes his grip on protrusions 230a and 230b, spring 254 biases the tongs 200 to the open position.

Abutment members (not shown) may be provided to prevent the tongs from opening past a predetermined open position, such that the abutment members may be placed on one of handles 220a and 220b to stop those handles from rotating about their common axis beyond a predetermined point. It is at that point that the abutment members contact each other to stop further rotation. In this embodiment, the closed position may be defined by the abutment of bowls 220a and 220b, which will stop further closing of the tongs 220.

Provided on the sides of joints 249b are openings 244, which align with each other. Extending through and between openings 244 is a locking pin 246 which is movable along the oblong track of openings 244. Thus, locking pin 246 is movable between one end and the other of openings 244 in a slidable fashion. Locking pin 246 is arranged to be substantially parallel to pin 248, throughout its movement.

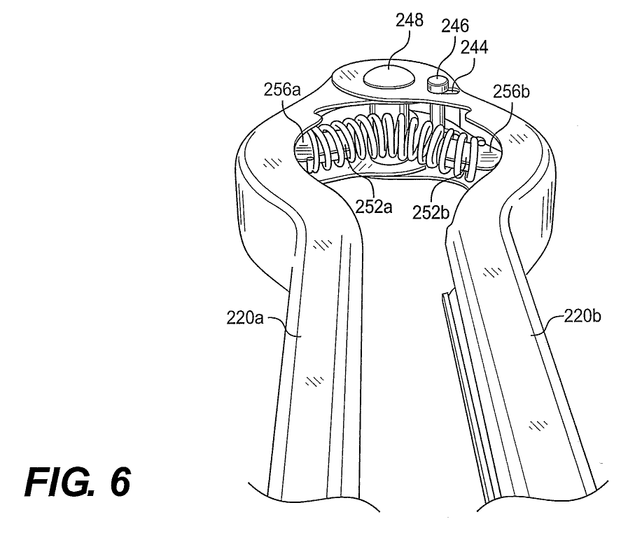

Provided on handle 220a, at the circular joints 249a near pin 248, are notches 242 (one shown). When handles 220a and 220b are rotated to the closed position, notches 242 align with one side of the openings 244. Thus aligned, locking pin 246 may be slid toward that one end of opening 244 so as to become positioned within slot 242. Once positioned therein, locking pin 246 prevents slot 242 from rotating out of alignment with openings 244, which in turn retards the movement of arms 220a and 220b, locking the tongs in the closed position. FIG. 6 shows the locking pin 246 positioned in the locking position.

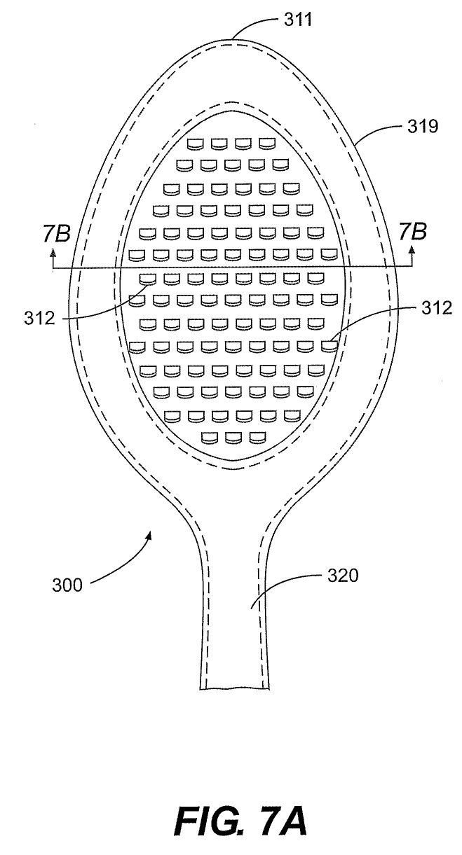

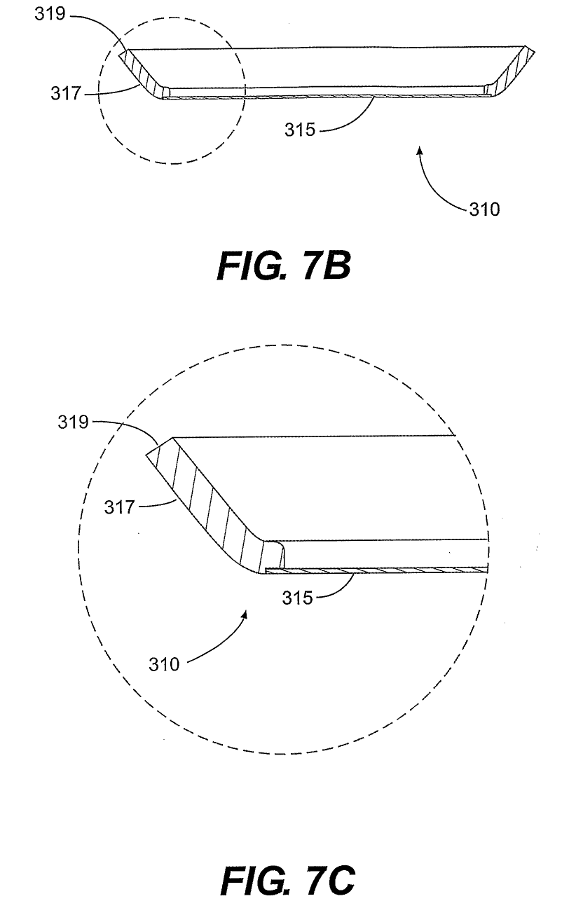

FIGS. 7A-7C show another embodiment of the invention in which a bowl 310 includes a flat section 315. As shown in FIG. 7A, a spoon 300 is provided. Spoon 300 includes bowl 310 attached to a handle 320. Handle 320 is attached to the bowl at a location opposite leading edge 311 of bowl 110.

Bowl 310 includes a number of grating holes 312, which form a rubbing zone. The structure and function of the grating holes 312 are similar to that of grating holes 112 described above with respect to the other embodiments.

In this embodiment, bowl 310 includes a flat section 315. Bowl 310 still includes concave and convex surfaces. As shown in FIGS. 7B and 7C, bowl 310 is generally shaped as a curvilinear plane, but with the trough of the curvilinear plane being flattened at section 315. Thus, the curvilinear portion of bowl 310 is defined by section 317, which extends from the flat section 315 to the edge of bowl 310. In other embodiments, section 317 may be straight, or partially curved.

In this embodiment, flat section 315 is a separate piece attached to the underside of bowl 310 of spoon 300 so as to cover a large opening in the bottom of the bowl. Flat section 315 includes the rubbing zone having grating holes 312. Thus, flat section 315 may be machined separately to form grating holes 312 therein, before being secured (removably or unremovably) to the underside of bowl 310. For example, section 315 can be attached by brazing, welding, or the use of an a waterproof adhesive.

The benefit of this embodiment is that it is often easier and/or less costly to form the grating holes 312 on a flat surface than on a curved surface. Thus, the rubbing-zone insert may be formed separately from the spoon 300, and added in a later manufacturing step. Naturally, the spoon would be formed with an opening in the bottom of the bowl that is of the proper size and shape to fit the rubbing-zone insert.

In other embodiments, flat section 315 may be integrally formed in the bowl 300.

1-8. (canceled)

9. A pair of tongs comprising:
a first spoon-shaped implement comprising:
a bowl having an upper surface that is concave, an undersurface that is convex, and a leading edge; and
a handle that is attached to the bowl at a location substantially opposite the bowl's leading edge,
wherein the bowl has a plurality of grating holes through it that present a rubbing zone that is sufficiently rough that a gratable foodstuff can be reduced to small particles by rubbing it on the zone, and
wherein the first spoon-shaped implement is pivotably attached to a second spoon-shaped implement comprised of a second bowl having a concave uppersurface and a convex undersurface and a second handle that is attached to said second bowl, so that the two bowl uppersurfaces face each other and the two handles are movable, relative to one another, between (a) an open position, in which the two bowls are spaced apart, and (b) a closed position, in which the two bowls are touching or proximate to each other.

10. The tongs of claim 9, wherein the second bowl also has a plurality of grating holes through it that present a rubbing zone that is sufficiently rough that a gratable foodstuff can be reduced to small particles by rubbing it on the zone.

11. The tongs of claim 10, wherein the tongs also comprise a spring member that urges the handles toward the open position.

12. The tongs of claim 11, wherein
the two, spoon-shaped implements are pivotably attached to each other at the ends of their handles and
the two handles curve away from each other in a region adjacent the point where they are attached, so as to form a round gripping protrusion in that region.

13. The tongs of claim 12, wherein
the two spoon-shaped implements are attached to each other by a pivot pin and
the spring member is a coil spring mounted inside the gripping protrusion.

14. The tongs of claim 13, further comprising
a pair of opposed arms pivotably mounted on said pivot pin in between the two handles, each arm having
a pin member that protrudes toward the other arm's pin member, and wherein
the coil spring is mounted on said pin members, so as to cause said arms to press outwardly against said handles.

15. The tongs of claim 10, wherein the convex undersurface of the bowl of the first spoon-shaped implement generally defines a curvilinear plane and, as regards at least some of the grating holes, the hole's opening on the convex undersurface of the bowl has a scooping edge that arches above that plane and substantially faces toward the handle.

16. The tongs of claim 15, wherein
the second bowl also has an upper, food-holding surface that is concave, an undersurface that is convex, and a leading edge and
the convex undersurface of the second bowl generally defines a curvilinear plane and, as regards at least some of the grating holes, the hole's opening on the convex undersurface of the bowl has a scooping edge that arches above that plane and substantially toward the handle.

17. The tongs of claim 16, wherein the tongs also comprise a spring member that urges the handles toward the open position.

18. The tongs of claim 17, wherein
the two, spoon-shaped implements are pivotably attached to each other at the ends of their handles and
the two handles curve away from each other in a region adjacent the point where they are attached, so as to form a round gripping protrusion in that region.

19. The tongs of claim 18, wherein
the two spoon-shaped implements are attached to each other by a pivot pin and
the spring member is a coil spring mounted inside the gripping protrusion.

20. The tongs of claim 19, further comprising
a pair of opposed arms pivotably mounted on said pivot pin in between the two handles, each arm having
a pin member that protrudes toward the other arm's pin member, and wherein
the coil spring is mounted on said pin members, so as to cause said arms to press outwardly against said handles.

21. The tongs of claim 9, wherein the convex undersurface of the bowl of the first spoon-shaped implement generally defines a curvilinear plane and, as regards at least some of the grating holes, the hole's opening on the convex undersurface of the bowl has a scooping edge that arches above that plane and substantially faces away from the bowl's leading edge.

22. The tongs of claim 10, wherein a majority of the grating holes through the first bowl are larger than the majority of the holes through the second bowl.

23. The tongs of claim 22, wherein a majority of the grating holes through the first bowl have a scooping edge that spans a distance of about 2 to 3.5 millimeters and
a majority of the grating holes in the second bowl have a scooping edge that spans a distance of about 3.5 to 5 millimeters.

24. The tongs of claim 23, further comprising means for locking the handles in the closed position.

25. The tongs of claim 9, further comprising means for locking the handles in the closed position.

26. The tongs of claim 9, wherein the pivotal attachment of the tongs is configured to have substantially no pinch points.

27. The tongs of claim 9, wherein the tongs are pivotably attached with joints that have a substantially constant profile as the tongs are moved between the open and closed positions, to avoid pinch points.
